(19) United States
(12) Patent Application Publication
(10) Pub. No.: US 2023/0385423 A1
(43) Pub. Date: Nov. 30, 2023

(54) SMART WALL PAD PERFORMING SELF-SECURITY MONITORING AND OPERATING METHOD OF SAME

(71) Applicant: NORMA Inc., Seoul (KR)

(72) Inventors: Hyunchul Jung, Seoul (KR); Chang Nyoung Song, Seoul (KR)

(21) Appl. No.: 18/101,583

(22) Filed: Jan. 26, 2023

(30) Foreign Application Priority Data
May 26, 2022 (KR) 10-2022-0064557

(51) Int. Cl. G06F 21/57; G06F 21/62

(52) U.S. Cl. CPC G06F 21/577; G06F 21/6218

(57) ABSTRACT

The technical idea of the present invention relates to a wall pad for performing self-security monitoring and a method of operating the same. The wall pad according to the technical concept of the present invention includes a storage configured to store system data about an internal file system, a monitoring module configured to perform security monitoring on the internal file system, and a notification module configured to transmit a result of the security monitoring, wherein the monitoring module accesses the storage to check a data size of the system data, and determines whether the internal file system is attacked based on whether the checked data size is a predetermined value.

### CROSS-REFERENCE TO RELATED APPLICATION

This patent application claims priority to and the benefit of Korean Patent Application No. 10-2022-0064557, filed on May 26, 2022, the disclosure of which is incorporated herein by reference in its entirety.

### BACKGROUND

### Technical Field

The present invention relates to a smart wall pad performing self-security monitoring.

### Discussion of Related Art

With the improvement of network quality and the development of Internet of Things (IoT) technology, various network devices have been deployed in homes or offices, and each network device has been used for convenience of life by constructing a network capable of communicating with the outside. The IoT, which is one of the wireless Internet, refers to a technology for connecting various objects through wireless communication. The Internet of Things is at risk of being hacked by other devices if the Linux operating system, which is the basis of a number of IoT devices, does not have the right security on the device or does not update properly.

In particular, in Korea, where apartments are the main residential form, wall pads using the Internet of Things are located at each house. Although the wall pad is located inside a home where privacy is required, there is always a risk of hacking because there is no appropriate security monitoring means, and the need for wall pad security monitoring has emerged.

### SUMMARY

### Technical Problem

The present invention is to provide a smart wall pad performing self-security monitoring and operating method of the same.

### Technical Solution

A wall pad according to the technical concept of the present invention includes a storage configured to store system data about an internal file system, a monitoring module configured to perform security monitoring on the internal file system, and a notification module configured to transmit a result of the security monitoring, wherein the monitoring module accesses the storage to check a data size of the system data, and determines whether the internal file system is attacked based on whether the checked data size is a predetermined value.

In an embodiment, the monitoring module may include an application program inspector, and the application program inspector may extract a parity code for an application program stored in the storage, and may determine integrity of the application program based on the extracted parity code.

The application program inspector may determine whether a new application program is included in a verification program DB when the new application program is installed in the storage, and transmit information about the new application program to the notification module when the new application program is not included in the verification program DB.

In an embodiment, the application program inspector may receive a size of the full data of the application program when a new application program is installed in the storage, may determine whether the data size of the application program matches the full data size, and may transmit information about the application program to the notification module when the data size of the application program does not match the full data size.

In an embodiment, the monitoring module may include an operating system inspector, and the operating system inspector may receive the latest version information on the operating system, determine whether a version of the operating system installed in the storage matches the latest version information, and transmit information on the operating system to the notification module when the version of the operating system does not match the latest version information.

In an embodiment, the operating system may include a user data area, and the operating system inspector may determine whether there is unauthorized data in the user data area based on a permission data DB, and when the unauthorized data is included in the user data area, transmit information on the unauthorized data to the notification module.

The operating system may include bootloader data for booting the wall pad, and the operating system inspector may determine whether the bootloader data has a predetermined size, and when the bootloader data does not have the predetermined size, the operating system inspector may transmit information about the bootloader to the notification module.

In an embodiment, the monitoring module may include a system inspector, and the system inspector may determine whether the system is in a rooting state, and when the system is in the rooting state, the system inspector may transmit that the system is in the rooting state to the notification module.

In an embodiment, the monitoring module may include a vulnerability inspector, and the vulnerability inspector may check whether a vulnerability pattern included in a vulnerability DB is included in the output data of the wall pad, and when the vulnerability pattern is included, transmit information on the vulnerability pattern to the notification module.

In an embodiment, the monitoring module may include a wireless communication inspector, and the wireless communication inspector may check a peripheral access point, determine whether a pattern included in a threat DB is included in data received from the access point, and transmit information on the access point to the notification module when the pattern is included in the data received from the access point.

In an embodiment, the wall pad may further include a display, and the notification module may include an alarm data transmitter configured to transmit a security monitoring result to a manager terminal having a legitimate authority for the wall pad, and an alarm data display configured to display the security monitoring result on the display.

### BRIEF DESCRIPTION OF THE DRAWINGS

FIG. 1 is a block diagram illustrating a wall pad according to an example embodiment.

FIG. 2 is a flowchart illustrating a method of operating a wall pad according to an example embodiment.

FIG. 3 is a flowchart illustrating a method of operating a wall pad according to an example embodiment.

FIG. 4 is a flowchart illustrating a method of operating a wall pad according to an example embodiment.

FIG. 5 is a flowchart illustrating a method of operating a wall pad according to an example embodiment.

FIG. 6 is a flowchart illustrating a method of operating a wall pad according to an example embodiment.

FIG. 7 is a flowchart illustrating a method of operating a wall pad according to an example embodiment.

FIG. 8 is a flowchart illustrating a method of operating a wall pad according to an example embodiment.

FIG. 9 is a flowchart illustrating a method of operating a wall pad according to an example embodiment.

FIG. 10 is a flowchart illustrating a method of operating a wall pad according to an example embodiment.

FIG. 11 is a flowchart illustrating a method of operating a wall pad according to an example embodiment.

FIG. 12 is a block diagram illustrating a computing system configuring a mobile robot according to an example embodiment.

### DETAILED DESCRIPTION

Hereinafter, exemplary embodiments of the present disclosure will be described in detail with reference to the accompanying drawings. Advantages and features of the present disclosure and methods of achieving them will become apparent with reference to embodiments described in detail below together with the accompanying drawings. However, the technical spirit of the present invention is not limited to the following embodiments, but may be implemented in various different forms, and the following embodiments are provided to complete the technical spirit of the present invention and to completely notify a person having ordinary skill in the art to which the present invention belongs of the scope of the present invention, and the technical spirit of the present invention is only defined by the scope of the claims.

In adding reference numerals to elements in each drawing, it should be noted that the same elements will be designated by the same reference numerals, if possible, even though they are shown in different drawings. In addition, in describing the present invention, when it is determined that a detailed description of related known configurations or functions may obscure the gist of the present invention, the detailed description thereof will be omitted.

Unless otherwise defined, all terms (including technical and scientific terms) used herein have the same meaning as commonly understood by one of ordinary skill in the art to which the inventive concept belongs. In addition, terms defined in commonly used dictionaries are not interpreted ideally or excessively unless they are clearly specifically defined. The terminology used herein is for the purpose of describing embodiments and is not intended to be limiting of the present invention. In the specification, a singular form includes a plural form unless specifically mentioned in the text.

In addition, in describing components of the present disclosure, terms such as first, second, A, B, (a), (b), and the like may be used. The term is used only to distinguish a component from another component, and the nature, sequence, or order of the corresponding component is not limited by the term. When it is described that a component is “connected”, “coupled”, or “connected” to another component, the component may be directly connected or connected to the other component, but it should be understood that another component may be “connected”, “coupled”, or “connected” between the components.

It will be further understood that the terms “comprises” and/or “comprising” used in the present invention do not preclude the presence or addition of one or more other components, steps, operations and/or elements, as mentioned.

Components included in any one embodiment and components including a common function may be described using the same name in another embodiment. Unless stated otherwise, the description described in any one embodiment may be applied to other embodiments, and the detailed description may be omitted within a redundant range or a range that can be obviously understood by a person having ordinary skill in the art.

Hereinafter, some embodiments of the present invention will be described in detail with reference to the accompanying drawings.

Hereinafter, the present invention will be described in detail with reference to preferred embodiments of the present invention and the accompanying drawings.

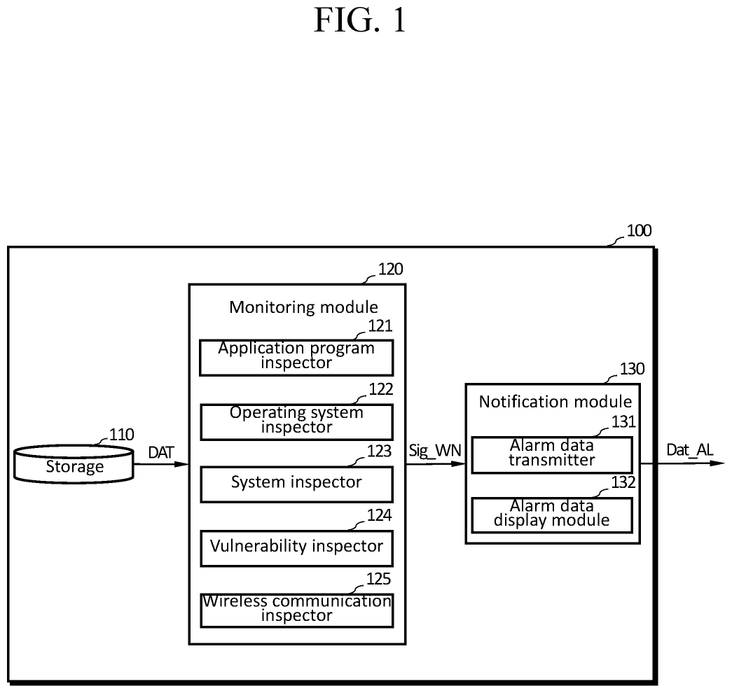

FIG. 1 is a block diagram illustrating a wall pad according to an example embodiment.

Referring to FIG. 1, the wall pad 100 is a terminal capable of performing various controls (e.g., access control, lighting, control of a home appliance, fire detection, etc.) with respect to a home, and may be configured to be attached to a wall surface of a kitchen or a living room of a home. The wall pad 100 may perform various types of control in a home through an access point (AP) connected by a network, and the network may include a Local Area Network (LAN), a Wide Area Network (WAN), the World Wide Web (WWW), a wired/wireless data communication network, a telephone network, a wired/wireless television communication network, 3G, 4G, 5G, 3rd Generation Partnership Project (3GPP), Generation Partnership Project (5GPP), Long Term Evolution (LTE), World Interoperability for Microwave Access (WIMAX), Wi-Fi, the Internet, a Local Area Network (LAN), a Wireless Local Area Network (Wireless LAN), a Wide Area Network (WAN), a Personal Area Network (PAN), Radio Frequency (RF), a Bluetooth network, a Near-Field Communication (NFC), a satellite broadcasting network, a digital broadcasting network, a Broadcasting Multimedia Network (DMB).

The wall pad 100 may include a storage 110, a monitoring module 120, and a notification module 130. In the present specification, an operation performed by each component (for example, the monitoring module 120 or the notification module 130) included in the wall pad 100 may be an operation actually performed by the processor of the wall pad 100 using an application program embedded in the storage 110 of the wall pad 100. The storage 110 may include a non-volatile memory, a volatile memory, a flash memory, a hard disk drive (HDD), a solid state drive (SSD), or the like. The processor may include at least one of a Central Processing Unit (CPU), a Graphic Processing Unit (GPU), a Neural Processing Unit (NPU), a RAM, a ROM, a system bus, and an application processor.

The storage 110 may store various data DAT for operating the wall pad 100. In some example embodiments, the various data DAT may include system data for an Operating System (OS) of the wall pad 100, application program data for an application that manages various detailed functions of the wall pad 100, user data including unique information of a user, and bootloader data for booting the wall pad 100.

The monitoring module 120 may receive the data DAT from the storage 110, perform various security monitoring on the wall pad 100 based on the data DAT, and output a warning signal (Sig_WN) to the notification module 130 to notify the manager or the user that a security critical matter is detected as a result of the security monitoring. The monitoring module 120 may include an application program inspector 121, an operating system inspector 122, a system inspector 123, a vulnerability inspector 124, and a wireless communication inspector 125 according to a monitoring target, but the technical idea of the present disclosure is not limited thereto.

The application program inspector 121 may monitor the application programs, such as whether the application programs installed on the wall pad 100 are authorized or whether the application programs are attacked. In this specification, an application is a program created to provide a specific function to a user by using the wall pad 100, and may be referred to as an application, an app, or the like.

The operating system inspector 122 may control hardware of the wall pad 100 and monitor an operating system providing a base environment for an application program in order to operate the wall pad 100. Specifically, the operating system inspector 122 may monitor the necessity of updating the operating system, whether user data or bootloader data of the operating system has been attacked, and the like.

The system inspector 123 may monitor whether the system for operating the entire wall pad 100 has been attacked. In an embodiment, the system inspector 123 may determine whether an attack has occurred on the entire system based on the system data of the wall pad 100, and may determine whether the system is vulnerable based on whether the system is in a rooting state.

The vulnerability inspector 124 may inspect whether the wall pad 100 has a vulnerability that is easily attacked, based on the output data of the wall pad 100. The wireless communication inspector 125 may determine whether there is an intention of an attack from the access point located around the wall pad 100.

According to the technical spirit of the present disclosure, the monitoring module 120 may be positioned inside the wall pad 100 to perform various security checks on the wall pad 100, and thus, data transmission/reception to the outside is not required as compared with a case where a security inspection is performed outside the wall pad 100, and thus, the possibility of an attack due to data transmission/reception is blocked, thereby enabling efficient and safe security monitoring.

The notification module 130 may output alarm data (Dat_AL) to a user or an administrator having a proper authority for the wall pad 100 in response to the warning signal (Sig_WN). To this end, the notification module 130 may include an alarm data transmitter 131 and/or an alarm data display module 132. The alarm data transmitter 131 may transmit alarm data (Dat_AL) to a predetermined terminal (e.g., a cellular phone owned by the user) owned by the user in response to the warning signal (Sig_WN). In some example embodiments, the alarm data (Dat_AL) may include information about a security-critical area (e.g., a name of an application program, a SSID of a threatening AP, etc.), a coping method for improving a security state (e.g., operating system updater, rooting state release, etc.), and the like, among the configuration of the wall pad 100. According to an exemplary embodiment of the present disclosure, the wall pad 100 notifies the user that security is in a dangerous state through the user terminal or the like, so that the user may know that the wall pad 100 is not safe through the portable terminal and the security state of the wall pad 100 may be improved, despite the user's location.

The alarm data display module 132 may display the alarm data (Dat_AL) through a display (e.g., a liquid crystal display (LCD), a touch screen, etc.) included in the wall pad 100, thereby transmitting the alarm data (Dat_AL) to the user. According to an exemplary embodiment of the present disclosure, the wall pad 100 displays that security is in a dangerous state to the user through the display, so that the user may intuitively check the security state of the wall pad 100 by viewing the wall pad 100, and accordingly, the security state of the wall pad 100 may be improved.

Although not illustrated, the wall pad 100 may further include a security improvement module, and the security improvement module may perform various operations (e.g., a rooting state release, an operating system update, vulnerability security, and threatening access point blocking) for improving a security state in response to the warning signal (Sig_WN).

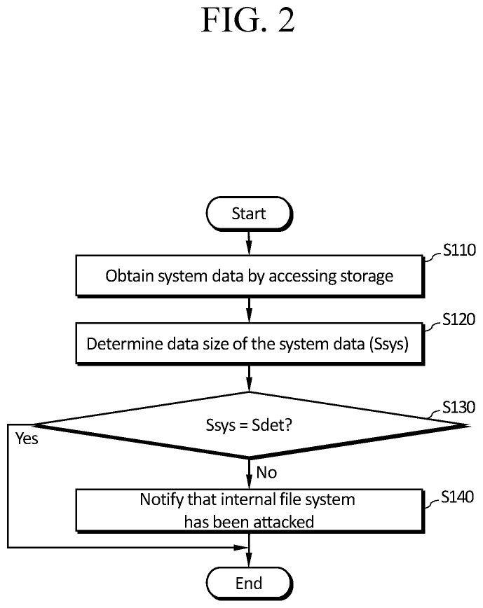

FIG. 2 is a flowchart illustrating a method of operating a wall pad according to an example embodiment. In detail, FIG. 2 shows a method of performing security monitoring on a system by the wall pad.

Referring to FIGS. 1 and 2, the wall pad 100 may obtain system data by accessing the storage 110 in operation S110, and may determine a data size of the system data (Ssys) in operation S120. In the present specification, the system data may mean all data stored in the storage 110 to operate the wall pad 100 except for the user data.

The wall pad 100 may determine whether the data size of the system data (Ssys) is equal to the predetermined data size (Sdet) S130. In some example embodiments, the predetermined data size (Sdet) may be received from the outside (e.g., a management server or a user for the wall pad 100).

When the data size (Sys) of the system data is equal to the predetermined data size (Sdet), the wall pad 100 may confirm that the system is not attacked, and when the data size (Sys) of the system data is not equal to the predetermined data size (Sdet), the wall pad 100 may determine that the system is attacked and may notify a user or a manager that the internal file system is attacked S140.

Since the wall pad 100 is specialized for various controls for an apartment, system access by a user, such as update or installation of a new application program, may be relatively small, and a change in system data may be less than system data initially set. Accordingly, when there is a change in the system data, it may be suspected that the system has been attacked. According to an exemplary embodiment of the present disclosure, when the system data does not have a predetermined data size based on the data size, security monitoring may be enhanced by notifying a user or an administrator of the fact that the system data does not have the predetermined data size, and as a result, security for the wall pad 100 may be enhanced.

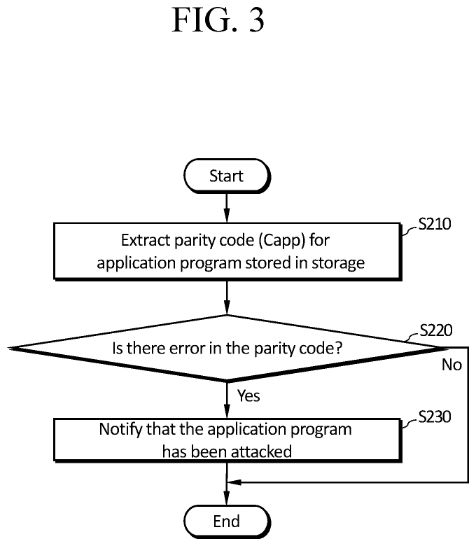

FIG. 3 is a flowchart illustrating a method of operating a wall pad according to an example embodiment; In detail, FIG. 3 shows a method of performing security monitoring on an application program by a wall pad.

Referring to FIGS. 1 and 3, the wall pad 100 may extract the parity code Capp of the application program from the storage S210. The parity code may mean a code inserted in data about an application program so as to detect an error about the application program.

The wall pad 100 may determine whether there is an error in the parity code S220. When there is an error in the parity code, the wall pad 100 may notify the user that the application program has been attacked S230, or may delete the application program by itself. When there is no error in the parity code, it may be determined that the application program is complete. In the present specification, integrity may mean that an application program or the like operates as intended by a user without being attacked.

According to an exemplary embodiment of the present disclosure, the wall pad 100 autonomously determines the integrity of the application, thereby performing efficient security monitoring without transmitting and receiving signals to and from the outside.

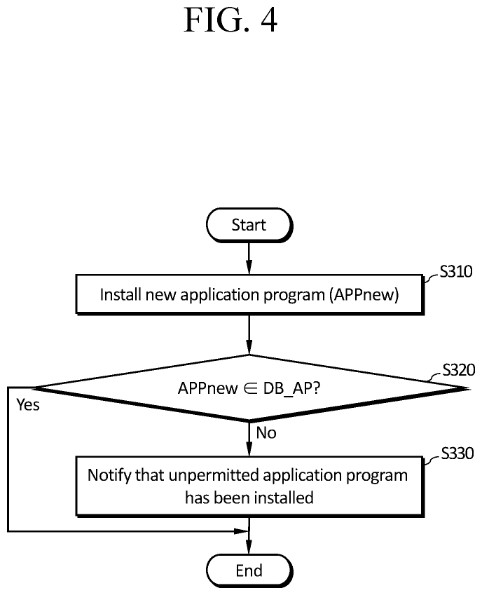

FIG. 4 is a flowchart illustrating a method of operating a wall pad according to an example embodiment; In detail, FIG. 4 shows a method of performing security monitoring on an application program by a wall pad.

Referring to FIGS. 1 and 4, when a new application program (APPnew) is installed S310, the wall pad 100 may determine whether the new application program (APPnew) is included in the verification program DB (DB_AP) S320. The wall pad 100 may stop the security monitoring for the new application program (APPnew) when the new application program (APPnew) is included in the verification program DB (DB_AP), and the wall pad 100 may notify the user that an unpermitted application program is installed when the new application program (APPnew) is not included in the verification program (DB_AP) S330. In another example, the wall pad 100 may autonomously delete the installed application program.

The wall pad 100 may have a relatively small number of application programs used due to the property of performing various controls in the home. Accordingly, a program that does not adversely affect the wall pad 100 may be managed by the verification program DB (DB_AP), and the verification program DB (DB_AP) may be provided from an administrator or the like. According to an exemplary embodiment of the present disclosure, only the application program included in the verification program (DB_AP) is installed on the wall pad 100, thereby preventing the installation of the application program having a possibility of attack on the wall pad 100 and increasing the security of the wall pad 100.

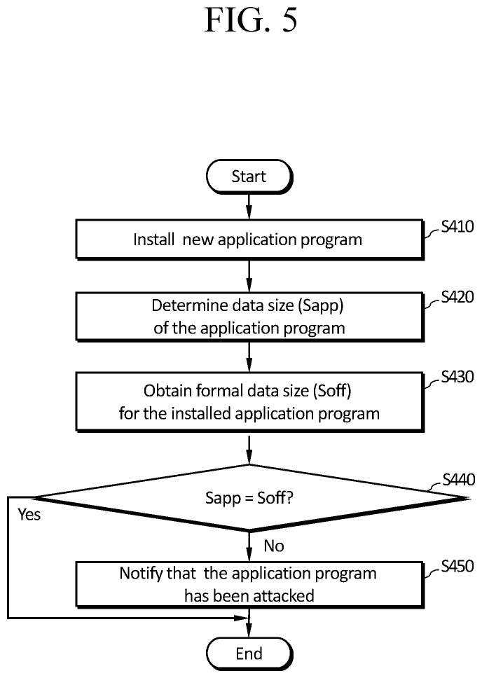

FIG. 5 is a flowchart illustrating a method of operating a wall pad according to an example embodiment; In detail, FIG. 5 shows a method of performing security monitoring on an application program by a wall pad.

Referring to FIGS. 1 and 5, when a new application program is installed S410, the wall pad 100 may determine a data size (Sapp) of the application program S420. In an example, the wall pad 100 may obtain the data size (Sapp) from metadata of an application program or may obtain the data size (Sapp) by measuring the data size of the application program.

The wall pad 100 may obtain an official data size (Soff) for the installed application program S430. In one example, the wall pad 100 may download the official data size (Soff) for the application program from the management server.

The wall pad 100 determines whether the data size (Sapp) of the installed application program is equal to the official data size (Soff), and if the data size (Sapp) is equal to the official data size (Soff), the security monitoring for the installed application program may be terminated, and if the data size (Soff) is not equal to the official data size (Sapp), the user or the like may be informed that the installed application program has been attacked S450. In another example, the wall pad 100 may autonomously delete the installed application program.

According to an exemplary embodiment, the integrity of the application program may be determined based on the data size, and accordingly, the installation of the application program having the possibility of an attack on the wall pad 100 may be blocked.

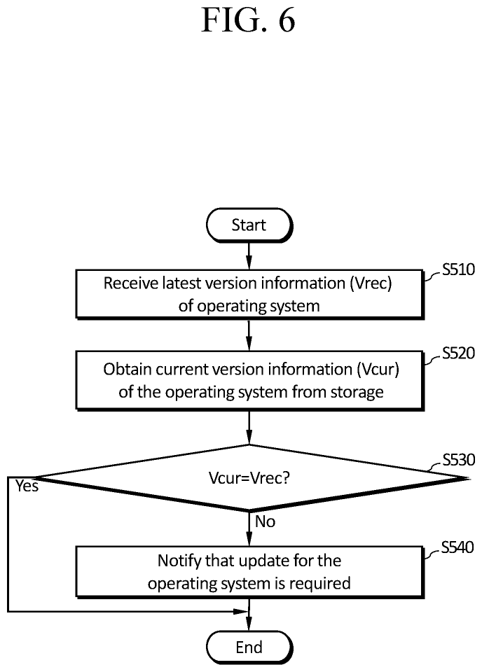

FIG. 6 is a flowchart illustrating a method of operating a wall pad according to an example embodiment. In detail, FIG. 6 illustrates a method of performing security monitoring on an operating system by the wall pad.

Referring to FIGS. 1 and 6, the wall pad 100 may receive the latest version information (Vrec) on the operating system S510. In one example, the wall pad 100 may receive the latest version information (Vrec) from the management server. The wall pad 100 may obtain the current version information Vcur of the operating system from the storage S520, and may check whether the current version information Vcur is the same as the latest version information (Vrec) S530. When the current version information Vcur is the same as the latest version information (Vrec), the wall pad 100 may terminate the security monitoring for the OS, and when the current version information Vcur is not the same as the latest version information (Vrec), may notify a user or the like that an update for the OS is required S540. In another example, the wall pad 100 may autonomously perform an update on the operating system.

According to an exemplary embodiment of the present disclosure, the wall pad 100 may autonomously perform periodic version checking on the OS, and accordingly, may increase security by maintaining the OS as the latest version.

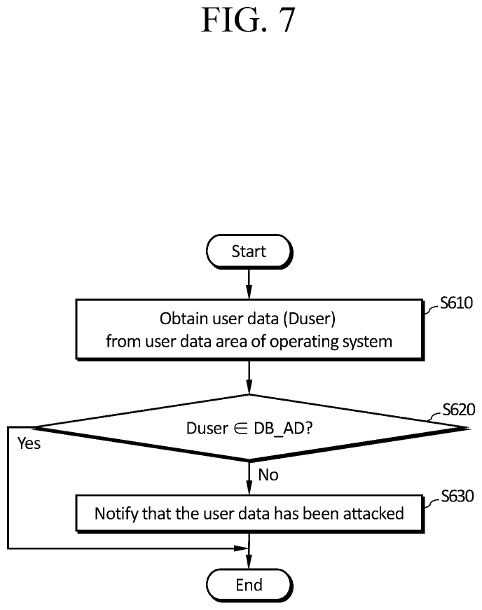

FIG. 7 is a flowchart illustrating a method of operating a wall pad according to an example embodiment. In detail, FIG. 7 shows a method of performing security monitoring on an operating system by the wall pad.

Referring to FIGS. 1 and 7, the wall pad 100 may obtain user data (Duser) from a user data area of an operating system S610. The wall pad 100 determines whether the obtained user data (Duser) is included in the permission data DB (DB_AD) S620, and if the user data (Duser) is not included in the permission data (DB_AD), notifies a user or the like that the user data (Duser) has been attacked S630. In another example, the wall pad 100 may improve the security of the wall pad 100 by deleting the attacked user data (Duser).

Due to the nature of the wall pad 100, only limited data may be stored in a user data area of an operating system. According to the exemplary embodiment of the present disclosure, the permission data DB (DB_AD), which is the legally stored data, may be secured, and the wall pad 100 may prevent an attack on the user data and improve security by determining other data to be unjustifiable data.

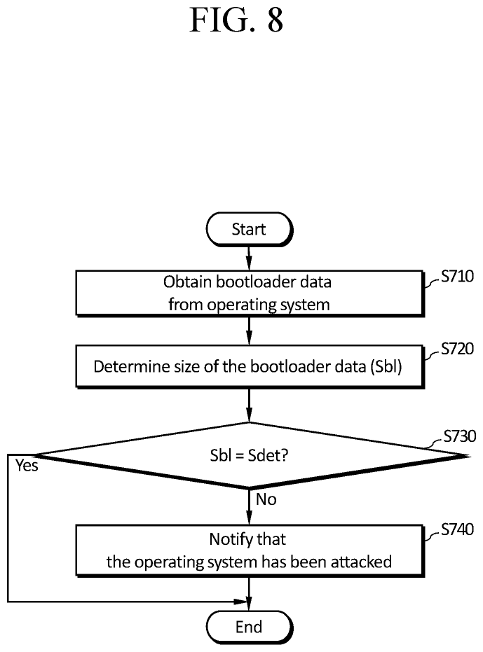

FIG. 8 is a flowchart illustrating a method of operating a wall pad according to an example embodiment. In detail, FIG. 8 shows a method of performing security monitoring on an operating system by the wall pad.

Referring to FIGS. 1 and 8, the wall pad 100 may obtain bootloader data from an operating system S710. The bootloader data may be data used to boot the wall pad 100. The wall pad 100 may determine the size (Sbl) of the bootloader data S720, and determine whether the determined size (Sbl) of the boot loader data is the predetermined size (Sdet) S730. When the determined size (Sbl) of the bootloader data is not the predetermined size (Sdet), the wall pad 100 may notify that the OS has been attacked S740. In another example, the wall pad 100 may restore the bootloader data to restore security for the attacked bootloader data.

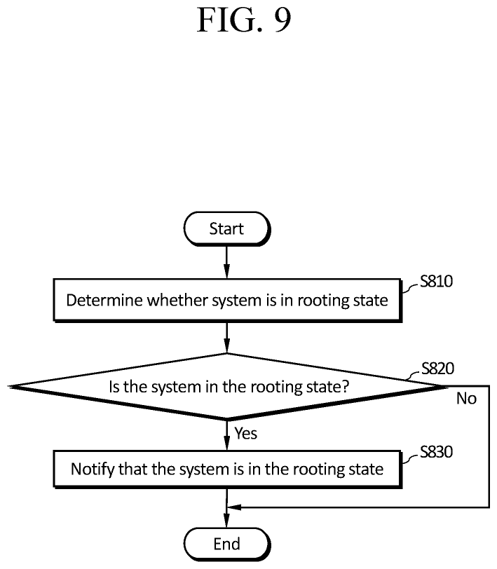

FIG. 9 is a flowchart illustrating a method of operating a wall pad according to an example embodiment. In detail, FIG. 9 shows a method of performing security monitoring on a system by the wall pad.

Referring to FIGS. 1 and 9, the wall pad 100 may determine whether the system is in a rooting state S810. The rooting state may mean a state in which the system may be changed with administrator authority for the wall pad 100. When the system is in the rooting state S820, the wall pad 100 may notify that the system is in the rooting state S830, or may release the system from the rooting state.

According to an exemplary embodiment of the present disclosure, the wall pad 100 may determine whether it is in a rooting state vulnerable to attack by itself, and may release the rooting state from the rooting state vulnerable to attack by notifying a user of the rooting state, and accordingly, security for the wall pad 100 may be improved.

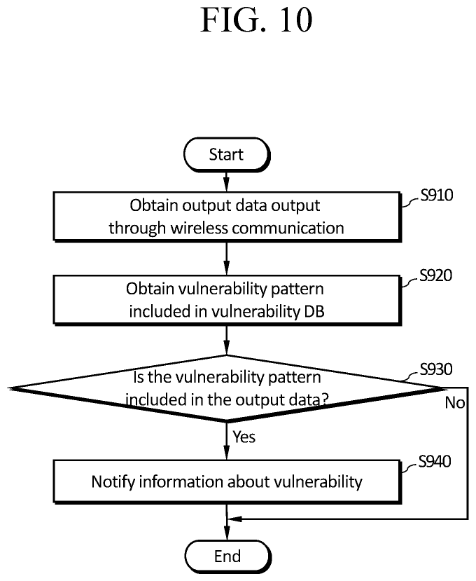

FIG. 10 is a flowchart illustrating a method of operating a wall pad according to an example embodiment; In detail, FIG. 10 shows a method of performing security monitoring for vulnerabilities by the wall pad.

Referring to FIGS. 1 and 10, the wall pad 100 may obtain output data output through wireless communication S910, and may obtain a vulnerability pattern included in a vulnerability DB S920. The vulnerability may refer to an inability point at which a normal operation cannot be performed in an attack on a network device, and the wall pad 100 may receive a vulnerability pattern from a predetermined source (for example, a vulnerability information website, a manager, or the like) through a server and update a vulnerability DB using the received vulnerability pattern.

The wall pad 100 may determine whether a vulnerability pattern is included in the output data S930, and when the vulnerability pattern is included in the output data, may notify a user or the like of information about the vulnerability S940, or may perform a task of solving the vulnerability.

According to an exemplary embodiment of the present disclosure, the wall pad 100 may identify and resolve a vulnerability by itself using the output data, thereby improving security for wireless communication without the help of an external device (for example, a management server).

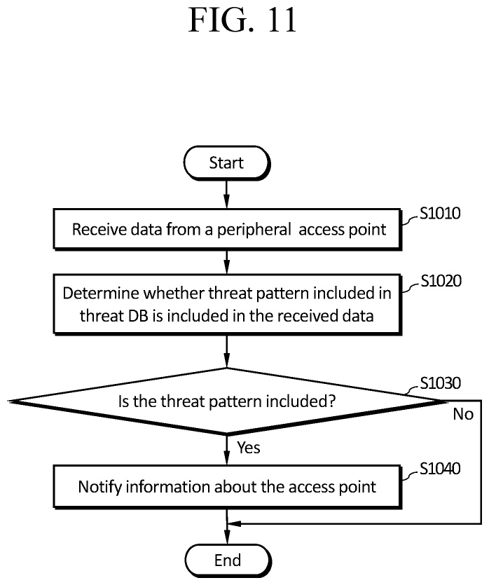

FIG. 11 is a flowchart illustrating a method of operating a wall pad according to an example embodiment. In detail, FIG. 11 shows a method of performing security monitoring for wireless communication by the wall pad.

Referring to FIGS. 1 and 11, the wall pad 100 may receive data from a peripheral access point S1010, and may determine whether a threat pattern included in the threat DB is included in the received data S1020. In the present specification, the threat refers to whether a network device has a purpose of obtaining data by attacking a network of an administrator or disturbing the network of the administrator by using a malicious code or the like, and the threatening network may have a tendency to attack the network of the administrator. In an embodiment, the wall pad 100 may determine the threat to the neighboring AP using the threat DB, and the threat DB may include information on a data pattern of the threat network, and may update the threat DB using a threat pattern obtained from a predetermined website.

The wall pad 100 may determine whether a threat pattern is included in the received data S1030, and when the threat pattern is included in the received data, may notify a user or the like of information about AP S1040, or may perform a resolution operation for a threatening network device such as blocking the AP.

According to an exemplary embodiment of the present disclosure, the wall pad 100 may autonomously determine the threat level of the peripheral network device and take a measure, thereby improving the security of the wall pad 100.

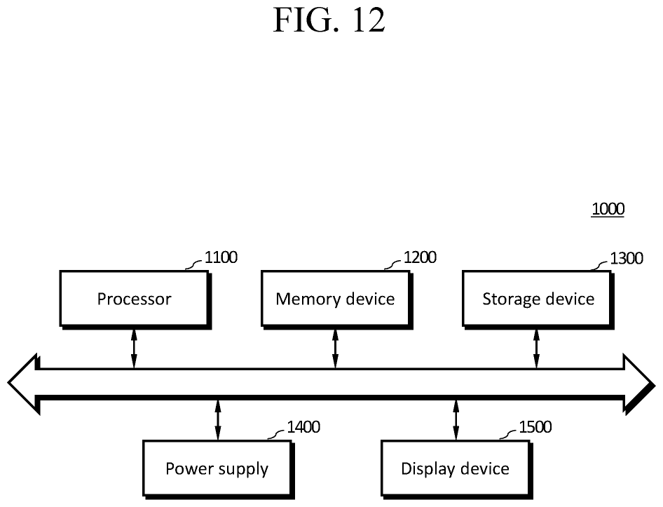

FIG. 12 is a block diagram illustrating a computing system configuring a mobile robot according to an example embodiment.

Referring to FIG. 11, the computing system 1000 may include a processor 1100, a memory device 1200, a storage device 1300, a power supply 1400, and a display device 1500. Although not illustrated in FIG. 12, the computing system 1000 may further include ports for communicating with a video card, a sound card, a memory card, a universal serial bus (USB) device, other electronic devices, etc.

As described above, the processor 1100, the memory device 1200, the storage device 1300, the power supply 1400, and the display device 1500 included in the computing system 1000 may configure the wall pad 100 according to embodiments of the inventive concept to perform a security monitoring method. In detail, the processor 1100 may perform the method of operating the wall pad 100 described with reference to FIGS. 1 through 11 by controlling the memory device 1200, the storage device 1300, the power supply 1400, and the display device 1500.

The processor 1100 may perform specific calculations or tasks. The processor 1100 may be a micro-processor or a Central Processing Unit (CPU). The processor 1100 may communicate with the memory device 1200, the storage device 1300, and the display device 1500 through a bus 1600 such as an address bus, a control bus, or a data bus. According to an embodiment, the processor 1100 may also be connected to an expansion bus such as a Peripheral Component Interconnect (PCI) bus.

The memory device 1200 may store data necessary for an operation of the computing system 1000. For example, the memory device 1200 may be implemented as a DRAM, a mobile DRAM, an SRAM, a PRAM, an FRAM, an RRAM, and/or an MRAM. The storage device 1300 may include a solid state drive, a hard disk drive, a CD-ROM, etc. The storage device 1300 may store programs, application program data, system data, operating system data, etc., related to the security monitoring methods described above with reference to FIGS. 1 to 11.

The display device 1500 is an output means for performing a notification with respect to a user, and when a security problem occurs, may display information about the security problem to the user and notify the user of the information. The power supply 1400 may supply an operating voltage required for an operation of the computing system 1000.

According to the technical concept of the present invention, by providing a wall pad which performs security monitoring by itself and an operating method thereof, the wall pad can autonomously investigate whether there is a security problem without intervention of a server, etc., and perform various countermeasures therefor, thereby preventing privacy information from being leaked through the wall pad.

Exemplary embodiments have been invented in the drawings and specification as described above. Although embodiments have been described using specific terms in the present specification, they are used only for the purpose of describing the technical spirit of the present invention and are not used to limit the meaning or limit the scope of the present invention described in the claims. Therefore, it will be understood by those of ordinary skill in the art that various modifications and other equivalent embodiments are possible therefrom. Therefore, the true technical protection scope of the present invention should be determined by the technical spirit of the appended claims.

What is claimed is:

1. A wall pad comprising:
a storage configured to store system data related to an internal file system;
a monitoring module configured to perform security monitoring on the internal file system;
a notification module configured to transmit a result of the security monitoring; and
a display,
wherein the monitoring module is configured to:
access the storage to check a total data size of the system data; and
determine whether the internal file system has been attacked based on whether the checked data size is a predetermined value,
wherein the monitoring module includes an operating system inspector and a system inspector,
wherein the operating system includes a user data area,
wherein the operating system inspector is configured to:
receive latest version information on the operating system;
determine whether a version of the operating system installed in the storage is identical to the latest version information;
transmit information on the operating system to the notification module when the version of the operating system is not identical to the latest version information;
determine whether there is an unauthorized data in the user data area based on an authorization data DB; and
transmit information on the unauthorized data to the notification module when the unauthorized data is included in the user data area;
wherein the system inspector is configured to:
determine whether the system is in a routing state; and
transmit the system is in the routing state to the notification module when the system is in the routing state, and
wherein the notification module comprises:
an alarm data transmitter configured to transmit a security monitoring result to a predetermined manager terminal having a proper authority for the wall pad, and
an alarm data display module configured to display the security monitoring result on the display.

2. The wall pad of claim 1, wherein the monitoring module includes an application program inspector, and the application program inspector extracts a parity code for an application program stored in the storage, and determines integrity of the application program based on the extracted parity code.

3. The wall pad of claim 2, wherein the application program inspector determines whether the application program is included in a verification program DB when a new application program is installed in the storage, and transmits information about the application program to the notification module when the application program is not included in the verification program DB.

4. The wall pad of claim 2, wherein the application program inspector receives a full data size of the application program when a new application program is installed in the storage, determines whether a data size of the application program matches the full data size, and transmits information on the application program to the notification module when the data size of the application program does not match the full data size.

5. The wall pad of claim 1, wherein the operating system comprises bootloader data for booting the wall pad, and
wherein the operating system inspector determines whether the bootloader data has a predetermined size, and when the bootloader data does not have the predetermined size, the operating system inspector transmits information about the bootloader to the notification module.

6. The wall pad of claim 1, wherein the monitoring module includes a vulnerability inspector, and the vulnerability inspector checks whether a vulnerability pattern included in a vulnerability DB is included in output data of the wall pad, and transmits information on the vulnerability pattern to the notification module when the vulnerability pattern is included in the output data.

7. The wall pad of claim 1, wherein the monitoring module comprises a wireless communication inspector, and the wireless communication inspector checks a peripheral access point, determines whether a pattern included in a threat DB is included in data received from the access point, and transmits information on the access point to the notification module when the pattern is included in the data received from the access point.
